(19) United States
(12) Patent Application Publication
(10) Pub. No.: US 2016/0149836 A1
(43) Pub. Date: May 26, 2016

(54) Communication and Messaging Architecture for Affiliated Real-Time Rich Communications Client Devices

(71) Applicant: Ecrio, Inc., Cupertino, CA (US)

(72) Inventors: Krishnakumar Narayanan, Pleasanton, CA (US); Michel E. Gannage, Los Altos Hills, CA (US); Venkata T. Gobburu, San Jose, CA (US); Nagesh Challa, Saratoga, CA (US)

(21) Appl. No.: 14/555,218

(22) Filed: Nov. 26, 2014

(51) Int. Cl. H04L 12/58; H04L 29/06; H04L 29/08

(52) U.S. Cl. CPC H04L 51/04; H04L 67/10; H04L 65/1006; H04L 65/1016

(57) ABSTRACT

A real-time rich communications (“RTC”) architecture consolidates a SIP/IMS framework and other frameworks for the desired communication and messaging services into a RTC host, which functions like a client to a SIP/IMS core in an IMS network, but which functions like a server to any number of RTC client devices over any number and any type of RTC capable networks. Advantageously, the RTC host may manage the RTC functions in the RTC clients without requiring support from any network infrastructure. Advantageously, the frameworks may be but need not necessarily be modular to facilitate design flexibility, modification, and upgrade. Advantageously, an RTC client may be a thin client.

### BACKGROUND OF THE INVENTION

1. Field of the Invention

This invention relates generally to communication and messaging architectures, and more particularly to a communication and messaging architecture for affiliated real-time rich communications client devices.

2. Description of the Related Art

Many different types of digital electronic devices incorporate a rich communications capability, either as a primarily function, an ancillary function, or simply as an additional function. The number and type of devices has grown dramatically, and each device category, manufacturer, and service may have a wide range of device platforms and operating systems, and multiple application environments, and are required to interoperate across many networks and systems. Since applications typically are device and service specific, this has limited the availability and use of new functions and capabilities to selected devices. The time and investment required to implement a new capability across an entire, complex device portfolio continues to increase as the range and type of devices increases. Developers, device suppliers, and service providers need a better means to support many device types and models with lower incremental time, cost, and risk to fully utilize investments and to offer services and value to more customers and markets.

Long Term Evolution (“LTE”) is a relatively recent standard developed by the Third Generation Partnership Project (“3GPP”) for wireless communication of high speed data for mobile phones and data terminals. Voice over LTE (“VoLTE”) has become the preferred industry choice for providing voice services over LTE. However, implementation of LTE on digital electronic devices has been hindered by power consumption issues and, in the case of VoLTE, long implementation lead times.

### BRIEF SUMMARY OF THE INVENTION

One embodiment of the present invention is a real-time rich communications (“RTC”) system comprising: a network infrastructure comprising one or more networks; a real-time rich communications (“RTC”) host installed on a RTC-enabled digital device, the RTC host comprising a plurality of core communication and messaging services for real-time rich communications and configured as a client to access Internet Protocol (“IP”) multimedia services running on a Session Initiation Protocol/Internet Protocol Multimedia Subsystem (“SIP/IMS”) core over the network infrastructure in a client-server relationship; and a plurality of affiliated RTC clients installed on respective real RTC-enabled digital devices and configured as clients to interact with the RTC host in respective client-server relationships. The RTC host is further configured as a server to provide any one or more of the core communication and messaging services to the affiliated RTC clients.

Another embodiment of the present invention is a real-time rich communications (“RTC”) host installed on a RTC-enabled digital device, comprising a plurality of core communication and messaging services for real-time rich communications. One of the core communication and messaging services using a Session Initiation Protocol/Internet Protocol Multimedia Subsystem (“SIP/IMS”) framework configured as a client to access Internet Protocol (“IP”) multimedia services running on a SIP/IMS core over a network infrastructure in a client-server relationship, and others of the core communication and messaging services using one or more frameworks that are coupled to the SIP/IMS framework. The RTC host further comprises a local call control server and a media framework configured as a server to provide any one or more of the core communication and messaging services to one or more affiliated RTC clients installed on one or more networked RTC-enabled digital devices in respective one or more client-server relationships.

Another embodiment of the present invention is a method for providing real-time rich communications comprising registering one or more affiliated real-time communications (“RTC”) clients installed on one or more RTC-enabled digital devices on a RTC host installed on a RTC-enabled digital device. The RTC host comprises a plurality of core communication and messaging services for real-time rich communications and configured as a client to access Internet Protocol (“IP”) multimedia services running on a Session Initiation Protocol/Internet Protocol Multimedia Subsystem (“SIP/IMS”) core over a network infrastructure in a client-server relationship; the one or more affiliated RTC clients being respectively configured as one or more clients to interact with the RTC host in respective one or more client-server relationships; and the RTC host being further configured as a server to provide any one or more of the core communication and messaging services to the one or more affiliated RTC clients. The method further comprises establishing a signaling plane between the one or more affiliated RTC clients and at least one unaffiliated RTC-enabled digital device over a network infrastructure using at least one of the communication and messaging services of the RTC host; and establishing a media transport plane between the one or more affiliated RTC clients and at least one unaffiliated RTC-enabled digital device over a network infrastructure using at least one of the communication and messaging services of the RTC host.

### BRIEF DESCRIPTION OF THE SEVERAL VIEWS OF THE DRAWINGS

FIG. 1 is a schematic diagram of a LTE device chipset or System on Chip device.

FIG. 2 is a schematic diagram of an abstraction model of client architecture for an illustrative implementation of VoIP, Video, RCS and SMS features.

FIG. 3 is a schematic diagram of an abstraction model of a client-host architecture for an illustrative implementation of VoIP, Video, RCS and SMS features.

FIG. 4 is a schematic diagram of an abstraction model of a variation of the client-host architecture of FIG. 3.

FIG. 5 is a schematic diagram of an abstraction model of another variation of the client-host architecture of FIG. 3.

FIG. 6 is a schematic diagram of an architecture for rich communications between a thin RTC client registered to a RTC host, an embedded client, and a virtual RTC client.

FIG. 7 is a schematic diagram of an architecture for rich communications between two thin RTC clients registered to respective RTC hosts.

FIG. 8 is a schematic diagram of an architecture for rich communications which involves conferencing.

FIG. 9 is a pictorial block diagram showing signaling and media transport via a RTC host between local affiliated RTC clients and a remote non-affiliated RTC client, including call throw among the local affiliated RTC clients.

FIG. 10 is a pictorial block diagram showing signaling and media transport via a RTC host between affiliated RTC clients and a remote non-affiliated RTC client, including call throw from a local affiliated RTC client to a remote affiliated RTC client.

FIG. 11 is a pictorial block diagram showing signaling and media transport via a RTC host between affiliated RTC clients and a remote non-affiliated RTC client, including call throw from a remote affiliated RTC client to a local affiliated RTC client.

FIG. 12 is a pictorial block diagram showing signaling via a RTC host between multiple local affiliated RTC clients and a remote non-affiliated RTC client.

FIG. 13 is a pictorial block diagram showing call blocking via a RTC host of a local affiliated RTC client.

FIG. 14 is a pictorial block diagram showing transcoding via a RTC host between multiple affiliated RTC clients and a remote non-affiliated RTC client.

FIG. 15 is a pictorial block diagram showing conferencing via a RTC host between multiple affiliated RTC clients and multiple remote non-affiliated RTC clients.

FIG. 16 is a pictorial block diagram showing signaling and media transport via a RTC host between local affiliated RTC clients including a vehicle head unit, and a remote non-affiliated RTC client.

FIG. 17 is a pictorial block diagram showing signaling and media transport via an internet and cable television box that incorporates a RTC host.

FIG. 18 is a pictorial block diagram showing signaling and media transport via a purpose-specific internet appliance which incorporates the RTC host.

### DETAILED DESCRIPTION OF THE INVENTION, INCLUDING THE BEST MODE

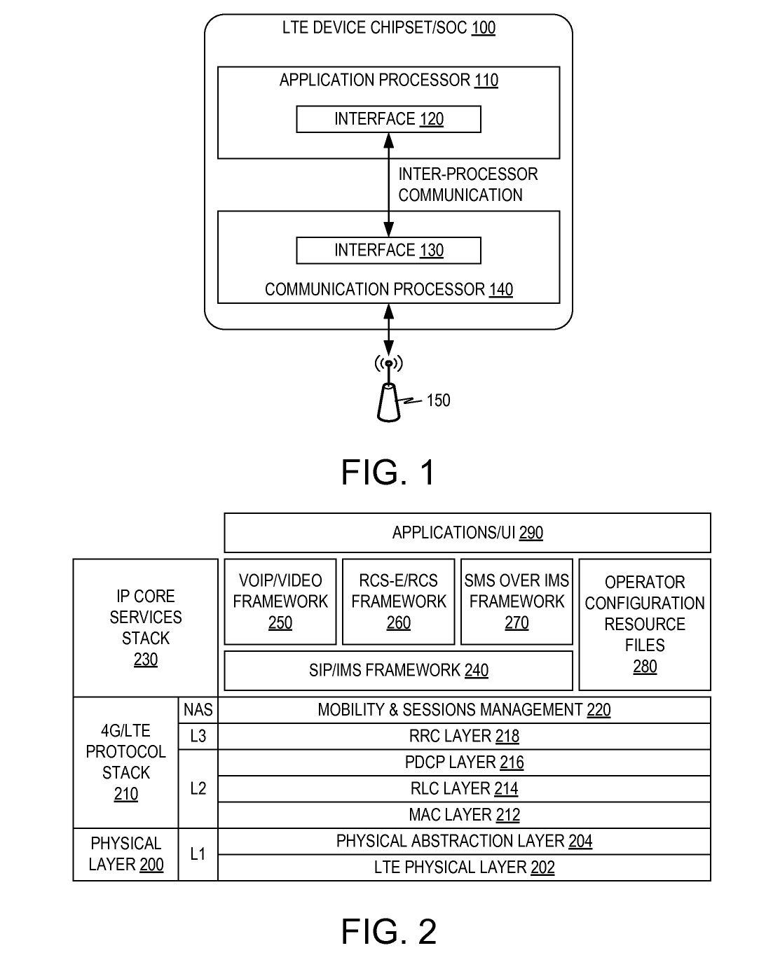

Real-time rich communications (“RTC”) over various Internet Protocol (“IP”) networks such as 4G/LTE, Wi-Fi, WiMAX and 3G is desirable for use in many different types of digital devices, including mobile personal digital devices such as, for example, smartphones, feature phones, tablets, ultrabooks and laptops, and various other digital devices such as, for example, machine-to-machine (“M2M”) digital devices, personal computers and workstations, and embedded digital devices which are used in such applications as manufacturing, monitoring, telematics, healthcare, utilities, home and office automation, group collaboration, home entertainment, gaming, and in-vehicle entertainment. Such real-time rich communications may be implemented using single processors (single or multiple core), multiple-processor chip sets, or systems-on-chip. FIG. 1 shows an illustrative chip set/System-on-Chip (“SoC”) 100 which includes a communication processor 140, illustratively a modem/baseband processor, for example, for handling network operations, and an application processor 110 for running various user applications. Implemented with limited functionality, the communication processor 140 may have lower power consumption than the application processor 110. An interface 120 in the application processor 110 and an interface 130 in the communication processor 140 facilitate inter-processor communication.

Processors, chip sets, and systems-on-chip suitable for rich communications via IP networks, including, for example, 4G/LTE, Wi-Fi, WiMAX and 3G, are quite varied. The relative processing power and power consumption of the application processor 110, or of its cores if a multicore processor, and the communication processor 140 may vary substantially from chip set to chip set, as may the particular implementations of the application processor 110 and the communication processor 140. The application processor 110, for example, may be single core or multi-core (dual core or quad core, for example). If multi-core, the various cores may be optimized for different purposes; for example, low latency, high quality of service, and low power consumption through either low power dissipation or aggressive power management. A given chip set may have one communication processor suitable for several rich communications protocols, or multiple simple communication processors each specializing in a particular rich communications protocol.

Custom real-time rich communications client architectures may be developed for such chip sets. Alternatively, a distributed services modular client architecture may be used to implement IP-based real-time rich communications services, including VoLTE, video calling, and companion rich communications services (“RCS”), in a flexible manner among a wide variety of different types of processors, chip sets, systems-on-chip, and cloud resources. In one example of such a client architecture, the various services, which may also be referred to as functions, may be distributed among two or more processor cores in accordance with a number of factors, including power requirements, media latency, quality of service, and any other considerations as may be desired. Such a client architecture is described in U.S. Pat. No. 8,639,253 issued Jan. 28, 2014 to Narayanan et al. and entitled “Real-Time Communications Client Architecture,” which hereby is incorporated herein in its entirety by reference thereto. The client architecture uses a modular SIP/IMS framework with other services being placed into their own modular frameworks as well, so that a particular service framework may be plugged into the SIP/IMS framework if and when desired, and otherwise omitted. The frameworks may be installed on various processor cores within the chip set or system-on-chip based on their power demands and profiles, media latency constraints, and quality of service constraints.

Alternatively, or in addition, a distributed services modular client architecture may be used to implement IP-based real-time rich communications services in a flexible manner with any type of RTC-enabled digital device having one or more processor cores and a virtual RTC client on the cloud. The various services may be distributed among the RTC-enabled digital device and the virtual RTC client, in accordance with a number of factors, including power consumption, media latency, on-time, performance and other considerations. The modular client architecture may also distribute signaling and media exchange plane functions among the RTC-enabled digital device and the virtual RTC client in the cloud. The distribution of these functions may be in accordance with a number of factors, including capturing media data, encode, send network, receive from network, decode, playback functions optimally done at the device, and other considerations. The modular client architecture may use a SIP/IMS framework, and may be modularized by placing certain services into their own framework so that a particular service may be plugged into the SIP/IMS framework if and when desired, and otherwise omitted. The frameworks may be installed in a virtual machine in the cloud, or divided between the device and a virtual machine in the cloud, depending upon the device capabilities and to allow optimal media processing and transport. Some of the frameworks may be replicated on both the device and the virtual machine in the cloud. Depending upon device and cloud load conditions, among other considerations, the frameworks in the device and/or in the cloud may be turned On or Off for load balancing and optimal real-time rich communications services. These techniques are described in greater detail in U.S. patent application Ser. No. 14/284,136 filed May 21, 2014 (Narayanan et al., Real-Time Rich Communications Client Architecture, Attorney Docket No. 1810.042.US2N), which hereby is incorporated herein in its entirety by reference thereto. Frameworks may be installed as described in U.S. Pat. No. 8,639,253 issued Jan. 28, 2014 to Narayanan et al. and entitled “Real-Time Communications Client Architecture,” which hereby is incorporated herein in its entirety by reference thereto.

As effective as these architectures are, situations arise in which the footprint or processing resource requirements of the RTC client on a digital device may be greater than desired, or in which adequate cloud resources are not available or allocating them to such RTC clients burdens or otherwise compromises network performance. As the number of RTC-enabled digital devices grow, it becomes difficult to manage the RTC functions from the network infrastructure both from the client-network connectivity as well as deployment cost point of view. While not necessarily precluding the use of these other architectures, the architecture described in detail herein consolidates a SIP/IMS framework and other frameworks for the desired services into a RTC host, which functions like a client to a SIP/IMS core in an IMS network, but which functions like a server to any number of RTC client devices over any number and any type of RTC capable networks. The RTC clients may signal and operate independently of one another, while the RTC host may maintain signaling and media transport with multiple RTC clients simultaneously. Advantageously, the RTC host may manage the RTC functions in the RTC clients without requiring support from the network infrastructure. Advantageously, the frameworks may be but need not necessarily be modular to facilitate design flexibility, modification, and upgrade. Advantageously, the frameworks may be coupled in many different ways, such as, for example, by combining different frameworks as one single framework (a single library, for example), loading different frameworks together at runtime, plugging modular frameworks together, and so forth, and in various combinations of the foregoing. Advantageously, an RTC client may be a thin client, thereby enabling the use of simpler, less expensive and in some cases, more reliable hardware, software and firmware, and rendering the RTC client suitable for deployment on a great variety of digital devices ranging from large powerful devices with state-of-the-art processors and copious memory, to very simple processor and controller implementations with limited memory. Advantageously, a RTC client and especially a thin RTC client may be relatively easy to implement.

As used herein, the term “real-time rich communications” refers to rich communications having a latency generally within acceptable norms for the rich communications application in question, in that any perceptible delay between the sender and the receiver are minimal and tolerable. In the case of VoIP, for example, the latency generally should not exceed about 150 ms.

As used herein, the term “device platform environment” refers to hardware, operating system, frameworks, and combinations thereof created for a device platform.

As used herein, the term “rich communication” refers to various (one or more in any combination) communication and/or messaging service capabilities that utilize IMS, including but not limited to: (a) voice calling, including standard voice, Voice over IP calling over IMS, and Voice over LTE; (b) Short Message Service (“SMS”) over IP Messaging over IMS; (c) packet switched video telephony including two-way video calling; (d) situation awareness, including real-time presence, capabilities, and location for contacts; (e) enhanced messaging, including both standard and advanced IP messaging including conversational messaging; and (f) sharing, including real-time, person-to-person video, image, and file sharing.

As used herein, the term “framework” refers to a collection of one or more software components such as application logic controllers (“ALC”), engines, enablers, and protocol stacks for carrying out one or more functions. A framework may but need not contain all of the components needed for carrying out its function, provided it has access to the absent components. Components such as engines and enablers, for example, may be provided outside of the framework through extensions so that they may be shared, or direct function calls from an ALC without sharing.

As used herein, the term “application programming interface” or API refers to a set of routines, data structures, object classes and/or protocols provided by libraries and/or operating system services in order to support the building of applications.

As used herein, the term “modular” refers to a software component which generally accomplishes a specific function in a generally self-contained manner, with clear logical boundaries representing a separation of concerns relative to other modules. A module's interface expresses the elements which are provided and required by the module, and the elements defined in the interface may be detectable by other modules. Communication between modules via their interfaces may be done using message passing or call interfacing, for example.

As used herein, the term Internet of Things (“IoT”) refers to the interconnection of digital devices within an infrastructure that includes the internet, and includes a variety of protocols, domains, and applications. Examples of IoT devices include connected cars, gaming consoles, utility meters, cameras, environmental sensors, remote controls, small embedded digital devices, smart and IoT hubs, healthcare equipment and implants, biochip responders, field operation devices, smart appliances, smart office equipment, and personal wearable devices, in addition to the conventional devices such as gateways, set top boxes, modems, personal computers, tablets and smartphones.

As used herein, the term “affiliated RTC client devices” refers to a group of RTC client devices which are networked to a RTC host over one or more networks such as the internet, operator networks, enterprise networks, home networks, vehicle networks, and social networks. An affiliation network may be thought of as a virtual network established among a group of devices which are within a physical and private place such as, for example, devices belonging to family members and their guests as well as family-associated IoT devices within a home or car, and employees and consultants as well as enterprise IoT devices within an office, or may be established among a group of devices whose users are engaged in a common activity or interest regardless of physical boundaries, such as sightseeing, riding public transportation, collaboratively working between and outside of offices, viewing a sporting event, and so forth.

In an RTC service, there are two types of functions: signaling and media exchange. Signaling refers to the steps involved in locating the recipient of the real-time rich communication. For example, in a phone call, the called party is the recipient. There are many protocols used in signaling and one of the standards to make RTC functions is using SIP protocols. Typically, there are a number of signaling messages exchanged between the user and the network which offers the RTC service, to locate the recipient, invite for rich communication, establishing the common schemes of rich communication, and when both parties (caller and called) agree, the signaling for rich communication is established. This signaling happens once per communication, and hence generally does not have strict timing requirements. The signaling components are usually done in software with protocol stacks and state machines.

Media Exchange refers to the steps involved after the signaling is established. It typically involves capturing media at the source, compress if necessary, encode if necessary, and transmit to the network for delivery to the recipient. Likewise, on the recipient side, media exchange steps involves receiving the media, decode if necessary, decompress if necessary, and playback or render the message. During a RTC session, there could be many media exchange operations so that the media packets arrive at the destination in time to have a good quality real time communication. Hence, the media exchange generally has strict timing requirements. The media exchange functions such as hardware accelerated and media compression/encoding/decoding tend to be closely tied to the device characteristics.

FIG. 2 is a schematic diagram of an illustrative abstraction model of a client architecture for real-time IP rich communications. While the abstraction model focuses on 4G/LTE, it is in principle applicable to other types of IP networks such as Wi-Fi, WiMAX and 3G. At the radio interface, the model is shown as a three layer protocol stack. The physical layer L1 (200) includes a LTE physical sublayer 202 and a physical abstraction sublayer 204. A 4G/LTE protocol stack 210 is shown in two layers L2 and L3. Layer L2 includes a Media Access Control (“MAC”) sublayer 212, a Radio Link Control (“RLC”) sublayer 214, and a Packet Data Convergence Protocol (“PDCP”) sub layer 216. Layer L3 includes a Radio Resource Control (“RRC”) sub layer 218. Operating over layers L1, L2 and L3 is the Mobility and Sessions Management or Non-Access Stratum (“NAS”) layer. The protocol stacks L1, L2, L3 and NAS constitute a 4G/LTE modem.

An IP core services stack 230 operates outside of the radio interface, and includes core services such as a SIP/IMS framework 240, Voice over IP (“VoIP”)/Video framework 250, RCS-e/RCS framework 260, and SMS over IMS framework 270. The frameworks 250, 260 and 270 may be modular and plug into the SIP/IMS framework 240, which also may be modular. Other module frameworks (not shown) may be prepared and plugged into the SIP/IMS framework 240 as well. The SIP/IMS framework 240 for the Internet Protocol Multimedia Subsystem (“IMS”) may be a standardized architecture which uses a Voice-over-IP (“VoIP”) implementation based on a 3GPP standardized implementation of the Session Initiation Protocol (“SIP”), and runs over the open standard IP protocols. Existing phone systems (both packet-switched and circuit-switched) may be supported. The SIP/IMS framework 240 may include protocol stacks, an application controller, a start-up engine, and a user agent engine. The voice/video framework 250 may include a VoIP engine, supplemental services, high definition voice, and video calling, and may be IR 92 compliant. The RCS-e/RCS framework 260 may include a presence engine, IP messaging engine, contact and group engine, file transfer engine, and a video share engine. The SMS over IMS framework also may be IR 92 compliant.

The SIP/IMS framework 240 contains a collection of software components which may include, for example, engines such as SIP User Agent and IMS Startup, and enablers such as IMS Library, SIP, SigComp, Presence, XDM, MSRP, RTP, RTCP. Enablers. SIP, RTP, RTCP and MSRP are also protocol stacks—SIP enabler implements SIP Protocol Stack, RTP enabler implements RTP Protocol Stack, RTCP enabler implements RTCP Protocol Stack, and MSRP enabler implements MSRP Protocol Stack.

The VoIP/Video framework 250 contains a collection of software components such as a VoIP ALC and a Video ALC. This framework implements functions such as one-to-one voice call over IP network, multi-party conference calls, and associated supplementary features such as call hold, call mute, and so forth. Functions may be defined by popular industry forums such as GSMA, 3GPP, OMA, IETF, and may be customized by service providers or other vendors in the ecosystem.

The RCS-e/RCS framework 260 contains a collection of software components such as a RCS-e ALC and a RCS ALC. This framework implements functions such as Instant Messaging, one-to-one or multi-party chats, presence, video sharing, image sharing and file transfer. Functions may be defined by popular industry forums such as GSMA, 3GPP, OMA, IETF, and may be customized by service providers or other vendors in the ecosystem.

The SMS over IMS framework 270 contains a collection of software components such as a SMS ALC. This framework implements functions such as sending and receiving SMS messages over IP network. Functions may be defined by popular industry forums such as GSMA, 3GPP, OMA, IETF, and may be customized by service providers or other vendors in the ecosystem.

The frameworks may be divided or combined if desired, and some elements of a framework may be moved to other frameworks and even to other processor cores. The VoIP/Video framework 250, for example, may be divided into a VoIP framework and a Video framework, if desired. However, care is needed to avoid degradation in performance and quality of the functions provided by the framework.

Operator configuration resource files 280 are customized for each operator and are provided for such parameters as custom timer values, domain names, compression and security parameters, and so forth.

Applications and user interface 290 operates over the frameworks 250, 260 and 270. The user interface may be prepared by the original equipment manufacturer, while the applications may be prepared by the original equipment manufacturer or by third parties.

While the client architecture of FIG. 2 is powerful and effective, it may be difficult to implement on relatively simple and low-powered RTC-enabled digital devices. Low end smartphones are an example of a type of RTC-enabled digital device that may not be suitably powerful to accommodate the client architecture of FIG. 2.

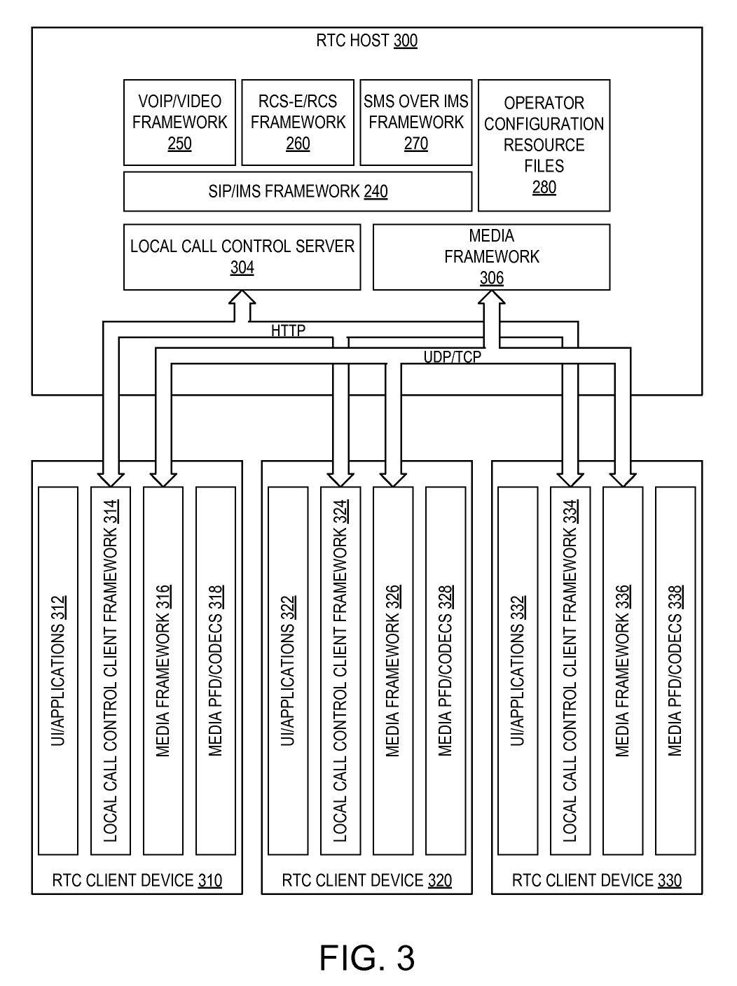

FIG. 3 is a schematic diagram of an abstraction model of a client-host architecture for an illustrative implementation of VoIP, Video, RCS and SMS features. A RTC host 300 may act as a server of RTC services to any number of RTC client devices over any number and any type of RTC capable networks. The RTC host 300 includes an IP core services stack which may be essentially similar to the IP core services stack 230 of FIG. 2, and includes a SIP/IMS framework 240 along with other core services such as the Voice over IP (“VoIP”)/Video framework 250, RCS-e/RCS framework 260, and SMS over IMS framework 270. Incoming standards compliant IMS/VoLTE calls may “ring” a designated or preferred RTC client device or may simultaneously “ring” all or any designated subset of affiliated RTC client devices. Any RTC client device may be used to place a standards compliant IMS/VoLTE call, even if it has no built-in cellular capability. Established IMS/VoLTE calls may be picked up from a first RTC client device and then transferred to a second device of choice. Established IMS/VoLTE calls may have any mix of content such as audio, video, messages, files, and so forth. Calls may involve all or some of these content types. Established calls may be further extended to conference additional RTC clients or transfer calls from one RTC client to another. Furthermore, the RTC clients may provide ease of use through shared access to an enhanced address book and call history.

The SIP/IMS framework 240, the SMS over IMS framework 270, and a VoLTE framework (which may be part of the VoIP/Video framework 250 or provided separately) are included for standards compliant connection to the operator's VoLTE service. The integrated RCS-e/RCS framework 260 provides support for Presence, Chat, Content Sharing, and File Transfer capabilities. It contains all the support needed for Local Call Control to identify the Call States such as Ringing, Connected, Media Exchange Established, Disconnected, and so forth, and to transfer or share the calls with RTC clients. As in the FIG. 2 architecture, the frameworks 250, 260 and 270 may be modular and plug into the SIP/IMS framework 240, which also may be modular. Other modular frameworks (not shown) may be prepared and plugged into the SIP/IMS framework 240 as well. Alternatively, the frameworks may be combined in any other desired manner.

The RTC host 300 executes the various RTC components as a client via the SIP/IMS framework 240 to a SIP/IMS core in an IMS network of the service provider. The IMS Startup engine (illustratively part of the SIP/IMS Framework) is responsible for authenticating the RTC host with SIP/IMS core so the RTC host is registered with the SIP/IMS core as a client. The authentication steps may include a simple username and password based procedure, or may include service provider credentials stored in the UICC. The SIP User Agent (illustratively part of SIP/IMS framework) is responsible for making and maintaining signaling sessions between RTC host and the SIP/IMS core. The signaling sessions are used to make or receive calls, send or receive messages between the RTC host and the SIP/IMS core. The RTP and RTCP Protocol Stacks (illustratively part of the SIP/IMS framework) are used to create and maintain media sessions between the RTC host and the SIP/IMS core. The media sessions carry the voice/video packets and other data used to support communication and messaging services.

The RTC host 300 may operate with an identity assigned by the service provider. For example, the identity may be a phone number assigned by the Mobile Operator. Furthermore, the identity may have secondary components such as an associated email address or a username with associated password that allow ease of use. The RTC host 300 may be implemented as a standalone unit, or installed on a variety of different RTC-enabled digital devices. The RTC host 300 may, for example, be implemented as a dedicated device that resides within a home, office or vehicle, and is shared among the users while within the home, office or vehicle, or may be integrated into a smartphone of one of the users and brought into the home, office or vehicle and is shared among the users while within the home, office or car.

The RTC host 300 may provide the ability to bridge standards compliant IMS/VoLTE calls to affiliated RTC client devices.

The RTC host 300 may be implemented with function calls or with a Services and Application Controller (“SAC”) as described in U.S. Pat. No. 8,639,253 issued Jan. 28, 2014 to Narayanan et al. and entitled “Real-Time Communications Client Architecture,” which hereby is incorporated herein in its entirety by reference thereto. Several SAC implementations are described in U.S. Pat. No. 8,613,002 issued Dec. 17, 2013 to Narayanan et al. and entitled “System, Method and Apparatus for Controlling Multiple Applications and Services on a Digital Electronic Device,” which hereby is incorporated herein in its entirety by reference thereto.

The architecture of FIG. 3 illustratively includes three RTC client devices 310, 320 and 330, each of which includes the components of a thin RTC client. The RTC client may be implemented as a WebRTC and/or a native RTC, as desired. The RTC client device 310 includes user interface and applications 312, a local call control client framework 314, a media framework 316, and media platform driver (“PFD”) codecs 318. A platform driver is basically a layer of software that abstracts various functionalities such as media capture, and play which are offered by platforms such as Windows, Android, iOS and Linux. Similarly, the RTC client device 320 includes user interface and applications 322, a local call control client framework 324, a media framework 326, and media PFD codecs 328, and the RTC client device 330 includes user interface and applications 332, a local call control client framework 334, a media framework 336, and media PFD codecs 338. The presence of a thin RTC client in the RTC client devices 310, 320 and 330 does not preclude the presence of a full RTC client such as shown in FIG. 2 or even a RTC client with a virtual RTC client in the cloud, as described in U.S. patent application Ser. No. 14/284,136 filed May 21, 2014 (Narayanan et al., Real-Time Rich Communications Client Architecture, Attorney Docket No. 1810.042.US2N), which hereby is incorporated herein in its entirety by reference thereto. Switching between the thin RTC client and any other RTC clients present may be manual or automatic such as during provisioning.

The RTC-enabled digital device may be provided with a web browser, which may be enabled for browser-based real-time rich communications such as voice calling, video chat, texting, and P2P file sharing using WebRTC. WebRTC is defined by the World Wide Web Consortium (“W3C”); see, for example, GOOGLE INC. WebRTC General Overview [online], 2011-2012 [retrieved on May 21, 2013]. Retrieved from the Internet: <URL: http://www.WebRTC.org/reference/architecture>. 3 pages. Advanced implementations have been done in the Chrome and Firefox browsers for PC and Mac desktop computers. See GOOGLE INC. WebRTC Demo [online], 2011-2012 [retrieved on May 21, 2013], retrieved from the Internet: <URL: http://www.WebRTC.org/demo>, 1 page.

The RTC components in the RTC-enabled digital device and in the RTC host may communicate over an IP-enabled protocol such as TCP/IP, UDP, HTTP, HTTPS, and Extensible Messaging and Presence Protocol (“XMPP”), as well as other protocols such as Session Traversal Utilities for Network Address Translation (“STUN”), Traversal Using Relays Around Network Address Translation (“TURN”), and Interactive Connectivity Establishment (“ICE”), and so forth, and may use a set of APIs for authentication, communications and messaging functions. Such APIs may be proprietary or public, and may be based on industry standards such as JSON. When APIs are made public, application developers for popular platforms such as iOS, Android, and Windows are able to incorporate these APIs in their applications, thereby allowing their applications to be a RTC client that utilizes a RTC host to perform RTC functions and services. As shown in FIG. 3, these communications occur in a client-server configuration, using a local call control server 304 in the RTC host 300 and respective local call control client frameworks such as 314, 324 and 334 in the RTC client devices 310, 320 and 330; as well as using a media framework 306 in the RTC host 300 and respective media frameworks such as 316, 326 and 336 in the RTC client devices 310, 320 and 330.

Authentication and security are desirable for real-time rich communications services. RTC clients may be provisioned and authenticated with the RTC host before using the services offered by RTC host. Provisioning refers to a method of setting connection parameters such as RTC host name, IP address, ports, inactivity timeout values, and so forth needed for RTC clients to communicate with a RTC host. Provisioning may be manual such as by having the user enter these parameters in a settings window in the RTC client, or may be automatic such as by automatically obtaining these parameters from the device such as from a configuration file. Authentication refers to a part of the registration procedure that a RTC client may follow before attempting to use the RTC services. Suitable authentication mechanisms for client-server communications include username-password techniques and digest-based hash techniques. When the RTC client is authenticated successfully by the RTC host, it is “registered” with the RTC host and may participate in RTC functions until the RTC client performs a “de-register” procedure with the RTC host, or the RTC host “blocks” the RTC client, which may occur due to a low battery condition, a guest device status, and so forth. Upon successful authentication of the RTC client with the RTC host, for example, the RTC host may return an authentication token to the RTC client. The RTC client may send this authentication token to the RTC host for subsequent service requests. Another technique involves the use of GPS coordinates of the RTC client for authentication. For example, a RTC client may be required to send its GPS coordinates during authentication, so that the RTC host may determine whether the RTC client is within the allowed geophysical area. This helps prevent unauthorized RTC clients connecting to the RTC host for illegal use of RTC services and functions. The RTC host may also encrypt signaling and media packets using industry standard techniques such as IPSec, which are already part of some of the service provider's communications and messaging networks. A smartphone may contain a Universal Integrated Circuit Card (“UICC”) which is offered by the service provider for identification and authentication of subscribers. The UICC contains an application called IP Multimedia Services Identity Module (“ISIM”) which stores parameters needed for identification and authentication of the subscriber with the IMS network. For identification and authentication purposes, the RTC host may use the ISIM parameters.

Advantageously, the RTC host 300 may include all of the core services generally used for real-time rich communications, illustratively a SIP/IMS framework, a Voice over IP (“VoIP”) framework, a video framework, a RCS-e/RCS framework, and a SMS over IMS framework. These frameworks may but need not be modular, and may be separate frameworks or may in some cases be combined into a single module, such as combining VoIP and video into one modular framework. In this manner, the RTC host 300 may implement real-time rich communications for a wide range of clients, including extremely thin clients. However, if a RTC host is intended to host only clients that do not require a particular service, the modular framework for that service may simply be deactivated or removed from the RTC host. A RTC-enabled digital client may not require a particular service from the RTC host either because it simply does not use the particular type of real-time rich communications, or uses either an embedded or virtual RTC client for that service. The combination of the RTC host 300 and the RTC clients in the devices 310, 320 and 330 allows for any suitable division of labor between the two. In general, a RTC host is well positioned to take on the burden of managing all the complex signaling, security and identity management aspects of the service, while either the RTC host or the RTC clients may take on the burden of managing media and content required for the communication or messaging.

For maximum flexibility, the RTC host 300 may include all of the core services generally used for real-time rich communications, but may also be provided the ability to negotiate with each RTC-enabled digital device to determine whether the RTC-enabled digital device is to use its own embedded or virtual RTC client to provide a particular service for a particular RTC-enabled digital device, or rely on the RTC host to provide the particular service for the particular RTC-enabled digital device. Using a policy control mechanism, the question of whether the RTC components in the device or the RTC host to be used for an RTC service may be resolved. This decision-making process may be done at the launch of the RTC service, at the launch of the RTC client, or at run time such as at call initiation or even during a call, based on load conditions in the RTC host and characteristics of the RTC-enabled digital device, such as, for example, available CPU, RAM/ROM, and power resources and power consumption on the RTC-enabled digital device.

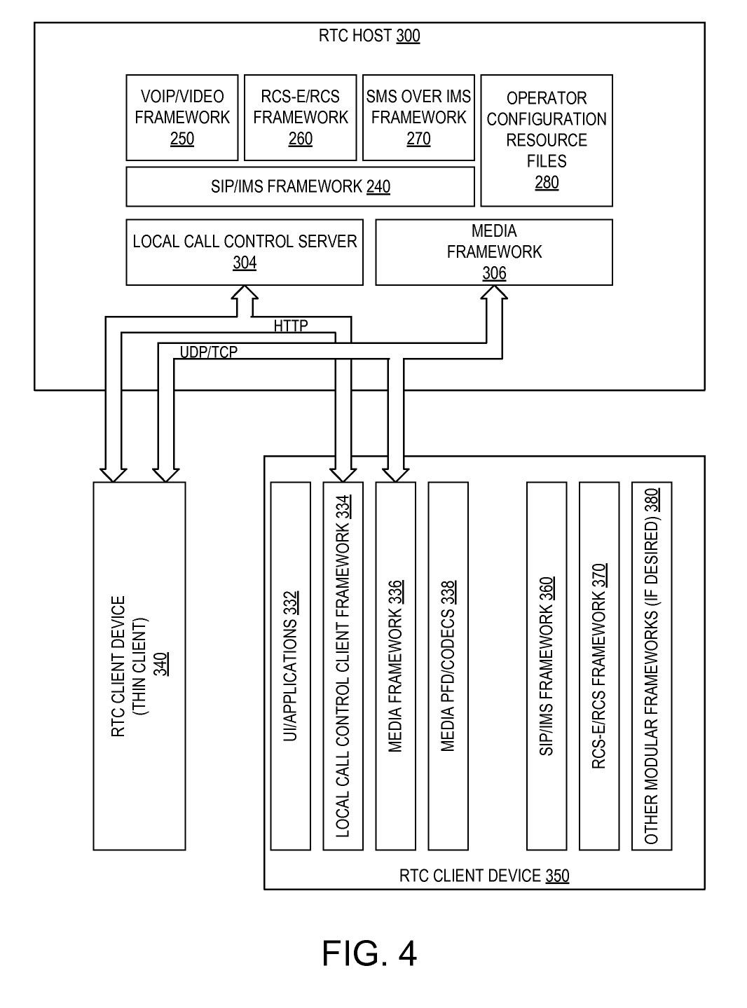

FIG. 4 is a schematic diagram of an abstraction model of a client-host architecture in which the RTC host 300 is well suited to handle an extremely thin RTC client such as in the device 340, but is also configured to defer to a capable client such as in the RTC client device 350, which includes its own SIP/IMS framework 360 as well as, illustratively, a RCS-e/RCS framework 370 and, if desired, other modular frameworks 380. Illustratively, during launch of the service, the policy may indicate that the RCS framework in the device to be used, whereupon the RCS framework on the RTC host may be disabled as to the particular RTC-enabled digital device. RCS services may continue to be provided by the RTC host to other RTC-enabled digital devices. When the RTC service provider network determines that the traffic on the RTC host is fairly light, the policy may be changed to use the RCS framework on the RTC host, whereupon the RCS framework on the device may be disabled. This allows greater flexibility to the RTC service providers to balance the load of computing and data processing resources on the RTC-enabled digital devices and the RTC host to offer optimal RTC service.

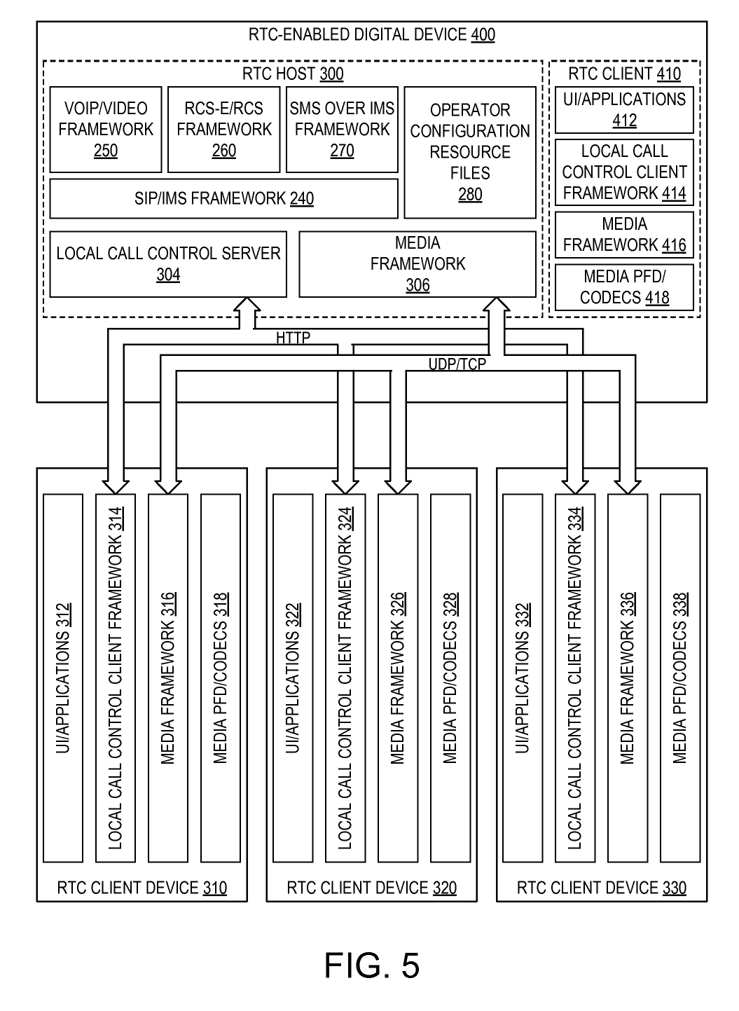

FIG. 5 is a schematic diagram of an abstraction model of a client-host architecture for an illustrative implementation of VoIP, Video, RCS and SMS features. FIG. 5 is similar to FIG. 3, except that a RTC client 410 is integrated with the RTC host on a RTC-enabled digital device 400. Specifically, the RTC client 410 includes user interface and applications 412, a local call control client framework 414, a media framework 416, and media PFD codecs 418. Communication between the RTC host 300 and the RTC client 410 may be done in any suitable manner, illustratively by UDP/TCP sockets or any other inter-process communication mechanism available on the RTC-enabled digital device 400. The client-host architecture of FIG. 5 is particularly suitable, for example, for a premium type smartphone.

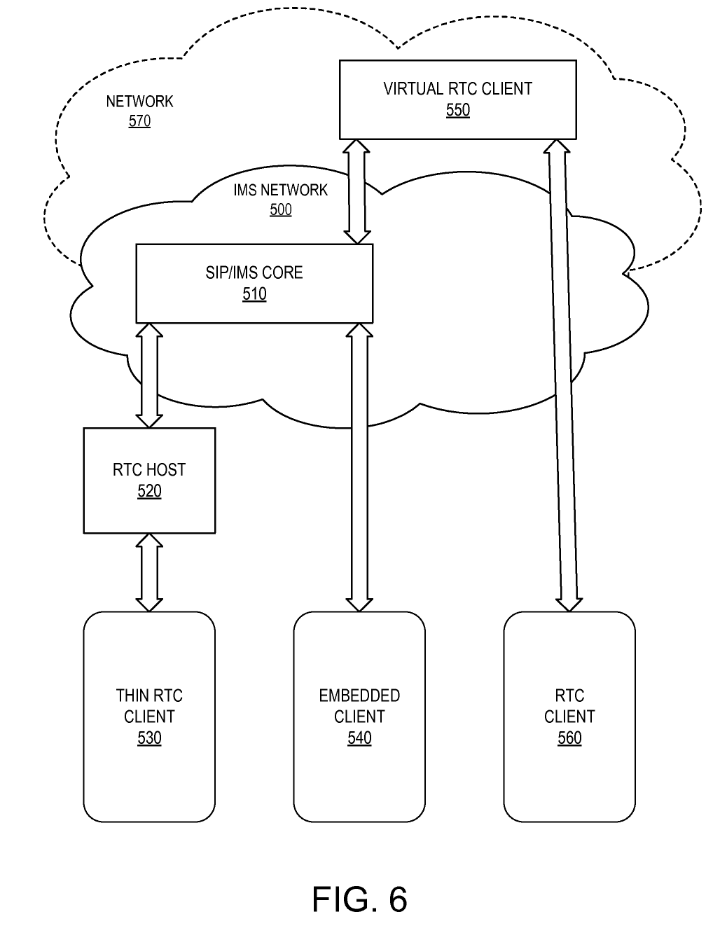

FIG. 6 shows an illustrative implementation of the signaling and media exchange plane functions among a RTC-enabled digital device illustratively operating as a thin RTC client 530, a RTC-enabled digital device illustratively operating as an embedded client 540, and a RTC-enabled digital device illustratively operating as a RTC client 560 in conjunction with a virtual RTC client 550. Signaling between the thin RTC client 530 and the embedded client 540 is handled by the SIP/IMS core 510 in the service provider's IMS network 500, and the RTC host 520 which acts as a client to the SIP/IMS core 510. Signaling between the thin RTC client 530 and the RTC client 560 with the associated virtual RTC client 550 is handled by the SIP/IMS core 510 in the service provider's IMS network 500, and the RTC host 520 which acts as a client to the SIP/IMS core 510. The SIP/IMS core 510 (meaning either a SIP core or an IMS core) is a well-known architectural framework which operates as a server for delivering IP multimedia services. The embedded client 540 may have all of the RTC components embedded therein, illustratively in the manner described in U.S. Pat. No. 8,639,253 issued Jan. 28, 2014 to Narayanan et al. and entitled “Real-Time Communications Client Architecture,” which hereby is incorporated herein in its entirety by reference thereto, and is therefore able to access the IP multimedia services available from the SIP/IMS core 510 in a client-server relationship over a signaling plane. The RTC client 560 along with the virtual RTC client 550 may have all of the RTC components distributed therebetween, illustratively in the manner described in U.S. patent application Ser. No. 14/284,136 filed May 21, 2014 (Narayanan et al., Real-Time Rich Communications Client Architecture, Attorney Docket No. 1810.042.US2N), which hereby is incorporated herein in its entirety by reference thereto, and is therefore able to access the IP multimedia services available from the SIP/IMS core 510 in a client-server relationship over a signaling plane. The virtual RTC client 550 resides in a network 570, which may be a separate IP network outside of the IMS network 500, or may be part of the IMS network 500, or the IMS network 500 may be part of the network 570. This provides great flexibility for the service providers, who may provide the SIP/IMS core 510 in the IMS network 500 while relying on a separate network or even a third party service provider to provide the virtual RTC client 550. Since there could be virtual RTC clients, such virtual RTC clients may be provided in one network or provided in many respective networks. The thin RTC client 530 may have some RTC components embedded therein or may have none, and may rely on the RTC host 520 for some or indeed all of the RTC components. The thin RTC client 530 may use one or more APIs such as, for example, HTTP REST APIs, which enable communication with the one or more RTC components in the RTC host 520 over a signaling plane, while the RTC host 520 accesses the IP multimedia services available from the SIP/IMS core 510 in a client-server relationship over a signaling plane. Using the signaling plane to set up the data transport, the thin RTC client 530 and the embedded client 540 may communicate RTP, RTSP, RTCP media (voice, video and text) over a media exchange plane, which may be outside of the RTC host 520 or may pass through the RTC host 520 for transport, as desired.

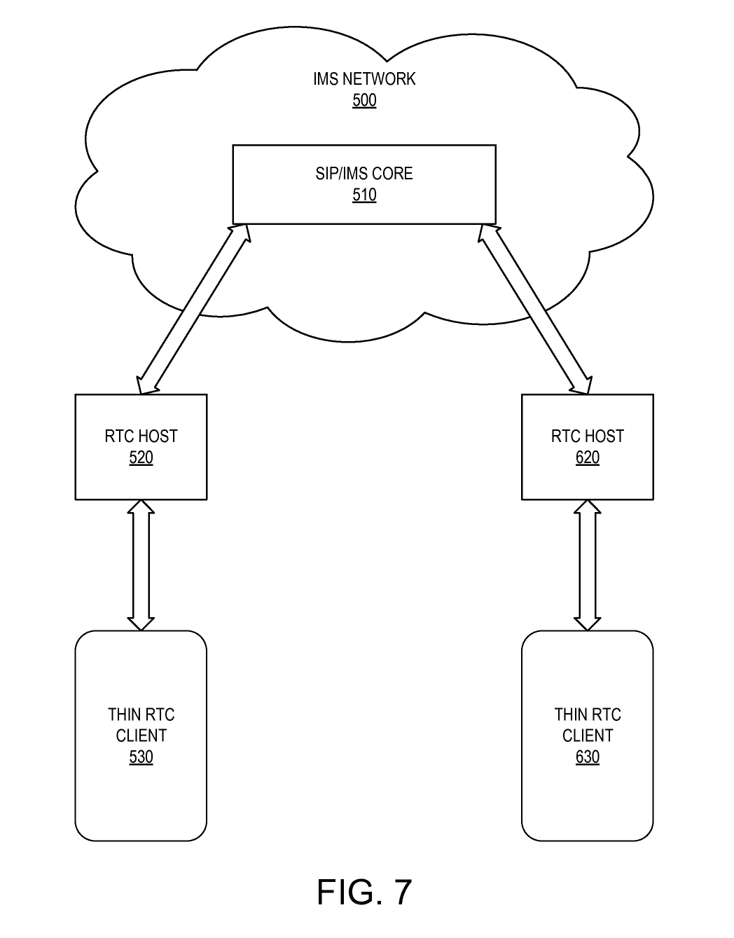

FIG. 7 shows an illustrative implementation of the signaling and media exchange plane functions among RTC-enabled digital devices operating as thin RTC clients 530 and 630. While only two RTC clients are shown, more than two may communicate in the same manner, and each RTC host may have many affiliated RTC clients. As in the FIG. 6 implementation, the thin RTC client 530 uses one or more APIs such as, for example, HTTP REST APIs, which enable communication with the one or more RTC components in the RTC host 520 over a signaling plane, while the RTC host 520 accesses the IP multimedia services available from the SIP/IMS core 510 in a client-server relationship over a signaling plane. Similarly, the thin RTC client 630 uses one or more APIs such as, for example, HTTP REST APIs, which enable communication with the one or more RTC components in RTC host 620 over a signaling plane, while the RTC host 620 accesses the IP multimedia services available from the SIP/IMS core 510 in a client-server relationship over a signaling plane. Using the signaling plane to set up the data transport, the thin RTC client 530 and the thin client 630 may communicate RTP, RTSP, RTCP media (voice, video and text) over a media exchange plane, which may be outside of the RTC host 520 or may pass through the RTC host 520 for transport, as desired

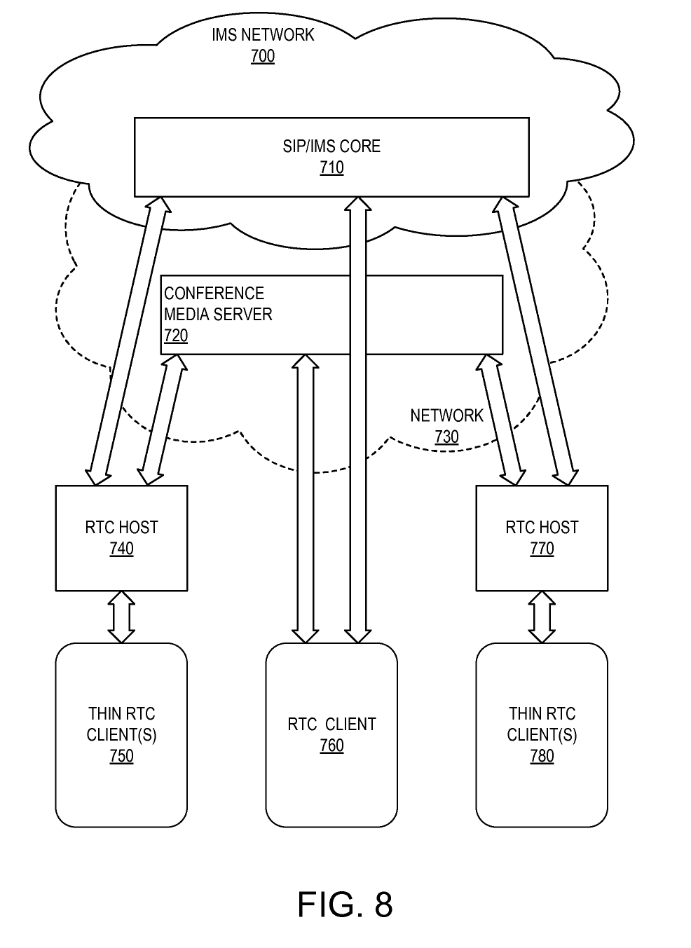

FIG. 8 shows an illustrative implementation of the signaling and media exchange plane functions among RTC-enabled digital devices operating as thin RTC client(s) 750 and 780, and RTC client 760. The signaling plane functions are as described herein for the FIG. 6 and FIG. 7 embodiments. However, the media exchange plane functions differ in that the data is not merely transported but is instead processed in some desired manner both in the RTC hosts 740 and in a cloud resource. To support a conference, for example, the RTC host 740 may manage the conference among the thin RTC client(s) 750, including such conversions and enhancements as may be needed or desired by the thin RTC client(s) 750, and the RTC host 770 may manage the conference among the thin RTC client(s) 780, including such conversions and enhancements as may be needed or desired by the thin RTC client(s) 780. A conference media server 720 manages the conference among the various “legs” of the conference, illustratively three as shown in FIG. 8, so that media may be shared among all of the conference participants. Since each of the RTC hosts 740 and 770 consolidates the conference media from its thin RTC clients (respectively 750 and 780) into one media stream, advantageously the RTC hosts 740 and 770 dramatically reducing the number of conference legs that need to be supported by the conference media server 720, thereby greatly reducing the demands on network resources. The capability for the RTC host 740 to manage a conference among the affiliated thin RTC client(s) 750, and the capability for the RTC host 770 to manage a conference among the affiliated thin RTC client(s) 780, is independent of the presence or absence of the conference media server 720.

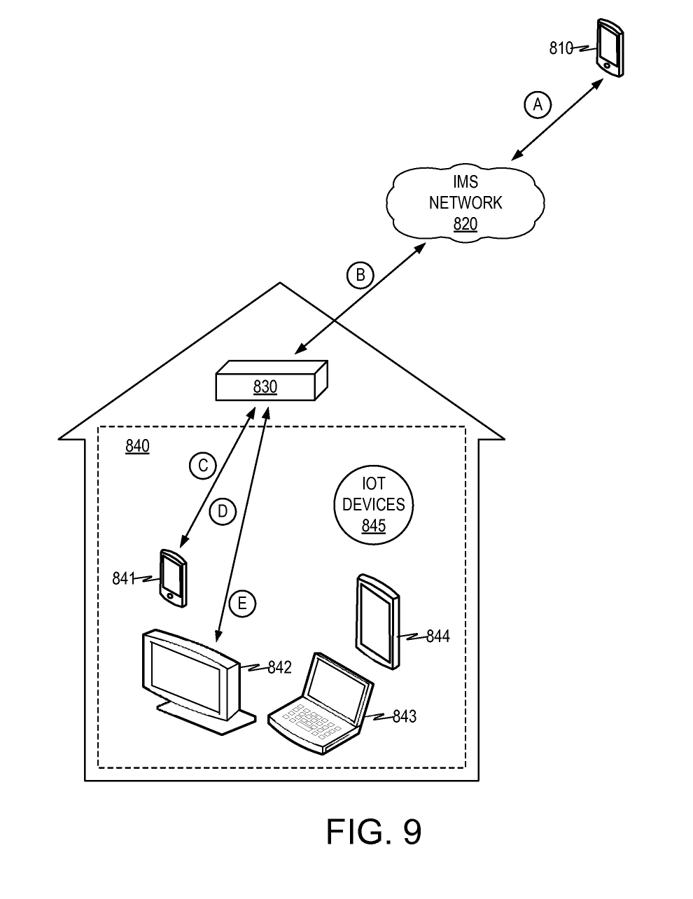

FIG. 9 is a pictorial schematic diagram showing an environment involving a basic call answer and call throw among a group 840 of affiliated RTC client devices registered to a RTC host 830. An affiliation network 840 includes, illustratively, a smartphone 841, a smart television 842, a personal computer 843 (desktop or laptop, for example), a tablet 844, and various “Internet of Things” (“IoT”) devices 845. If the RTC host 830 is combined with a RTC client in an RTC-enabled digital device as shown in FIG. 5, for example, such a RTC-enabled digital device may be considered to be within the affiliation network 840.

The tablet area of which the tablet 844 is an example is likely to experience substantial growth and in which RTC-enabled digital devices are expected to play a major role. The number of tablets in the market is growing rapidly and is replacing the traditional desktops, especially where mobility is highly desired. Most of these tablets connect to the internet through Wi-Fi, though some have LTE connections offered by mobile operators. Mobile operators who are launching VoLTE focus primarily on smartphones and may not plan to offer the VoLTE services for users from these tablets. However, they would like to benefit from increasing the number of VoLTE calls made on their networks, not only among VoLTE smartphones, but also between smartphones and tablets. In addition, Voice/Video traffic from tablets generally use Over-The-Top (OTT) communications services such as Skype, and terminate on smartphones via legacy 3G gateways or via the OTT network. This mechanism does not take advantage of the quality offered by the VoLTE service. There is a need to enable tablets to participate in high quality voice/video calls with smartphones without having to settle for low quality legacy voice/video calling services.

The IoT area of which the IoT devices 845 are examples is also likely to experience substantial growth and in which RTC-enabled digital devices are expected to play a major role. As the wireless networks become faster and more prevalent, the number of connected devices is expected to increase. There are many initiatives to address IoT in the industry. There is a need to connect these IoT devices with such RTC-enabled digital devices as VoLTE smartphones for seamless communications and messaging experience. The IoT devices usually follow light-weight data transfer protocols such as MQTT or XMPP, so that the CPU power and battery consumption in these devices may be kept low and optimal for their use. This results in the need for gateways and associated software to convert these IoT protocols to VoLTE protocols to enable communications and messaging among IoT devices and VoLTE devices.

With further reference to FIG. 9, the RTC host 830 may be any type of RTC-enabled digital device, including a standalone device, a router suitably modified to be a host, a home or office gateway suitably modified to be a host, a cable box suitably modified to the a host, a smartphone modified to be a host, a vehicle head unit suitably modified to be a host, and so forth. Examples of the network topology could be a home, office, vehicle, or even an ad hoc topology. The network topology is not restricted to a single local network and the RTC host 830 is capable of networking with any RTC client that is reachable through any one or more IP networks, whether local or wide area or even the internet. Moreover, multiple coordinated RTC hosts respectively having core services stacks may be used with the affiliated RTC client devices. However, to facilitate description, the setting is presented as a single building Wi-Fi network and a single RTC host. Furthermore, the multiplicity of RTC clients may be any mix of RTC enabled digital devices such as, for example, tablets (iOS, Android or Windows), smart televisions, and smartphones. The RTC host 830 is networked on the cellular network and operates as a VoLTE endpoint. An incoming VoLTE call may ring a designated device or all or any designated subset of affiliated RTC client devices. Any device that rings may answer an incoming call.

An illustrative process of engaging in a real-time rich communications call is shown in illustrated in FIG. 9. An IMS/VoLTE call is signaled from device 810 (path A) through the IMS network 820 to (path B) the RTC host 830. The call may be placed by any type of RTC-enabled digital device or system, represented by the smartphone 810. Operating as a VoLTE endpoint, the RTC host 830 accepts the call, and queries the set of registered clients to identify any one or more designated devices which may be available to take the call. In this example, only the smartphone 841 is designated, so the RTC host 830 determines that the designated device 841 is available and rings it (path C). Device 841 signals the RTC host 830 (path D) that it is active on the call, but in due course further signals the RTC host 830 (path D) that the call is to be “thrown” to another device, namely the smart television 842. As a result of the communications between the device 841 and the RTC host 830, the device 841 is aware of all other affiliated RTC clients that are available, and presents this information to the user for the user to make the selection(s). The RTC host 830 then places the outgoing VoLTE call on hold, and invites the device 842 to join the call (path E). Device 842 signals the RTC host 830 that it accepts the call, whereupon the RTC host 830 resumes the call with the remote device 810 (path E). In a similar fashion the RTC host 830 may also receive incoming SMS over IMS messages, which may then be delivered to one or more designated affiliated RTC clients. Likewise any designated affiliated RTC client may create and send an SMS message.

The IoT devices 845 may include IoT type endpoints that are not intended to be operated by a human and accordingly need not have a screen or keypad. An example is a temperature monitoring device programmed to periodically send a temperature reading to a pre-determined phone number. The simple message may be sent from the temperature monitoring device (illustratively one of the IoT devices 845) to the RTC host 830 which in turn forwards it as a LTE SMS to an identified recipient.

The RTC host 830 may include an optional IoT framework such as the AllJoyn service framework to support such IoT messages, and include logic to programmatically specify recipient addresses for outgoing SMS messages, parse income SMS messages, and deliver to designated RTC clients, and translate between the operator's SMS and RCS message formats and the message protocols/formats supported by the client device. In one example, the RTC-enabled client device may support the MQTT protocol or the D-bus protocol used by the AllJoyn service framework, and the RTC host 830 may translate bi-directionally between the MQTT protocol or the D-bus protocol and SMS used by the IMS/LTE network. An example of a RTC-enabled digital device having an IoT framework is an IoT hub such as the NEST hub available from Nest Labs, Inc. of Palo Alto, Calif., USA, and the WINK hub available from Wink Inc. of New York, N.Y., USA.

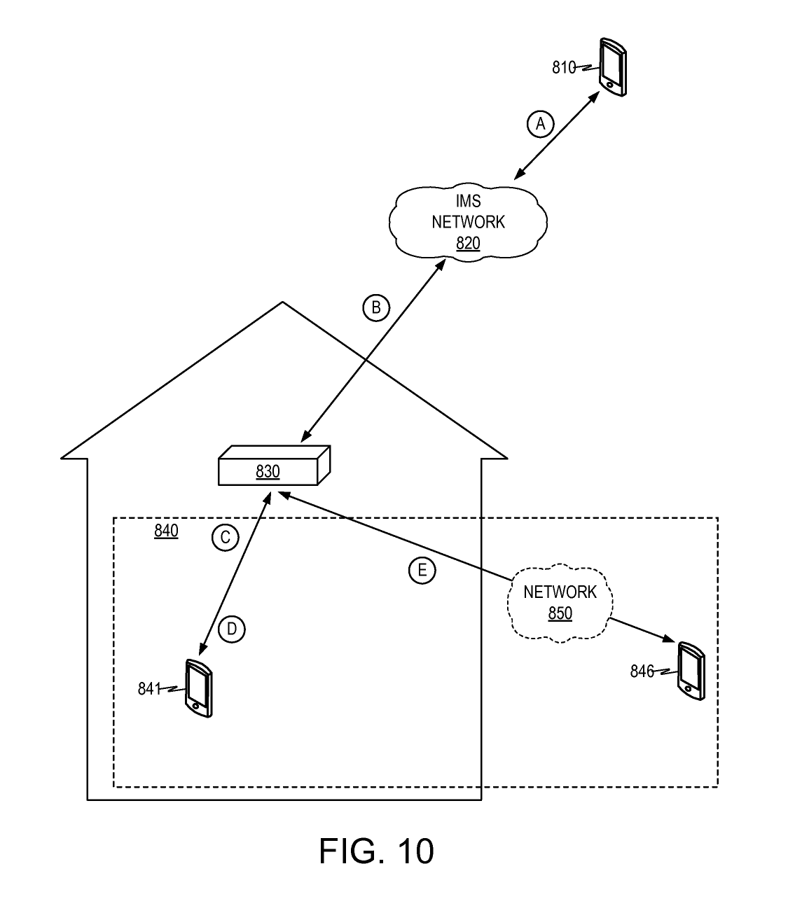

FIG. 10 shows a variation of the environment of FIG. 9 in which an affiliated RTC client 846 is outside of the local home or office network but within the affiliation network 840 and reachable through network 850. The network 850 may be any type of network, including, for example, an extended local network, a peer-to-peer network, a wide area network, an IMS network, the internet, and so forth. When an incoming call is made to the RTC host 830, the designated affiliated RTC client 841 rings (path C). Although not shown in FIG. 10, the affiliated RTC client device 846 may instead be the designated device for answering an incoming call, or indeed both affiliated RTC client devices 841 and 846 may be designated and thereby ring simultaneously, and the RTC client that answers the call may continue with the RTC operation. As shown in FIG. 10, the RTC client device 841 may answer the call (path D) and throw the call (paths D and E) to the RTC client device 845.

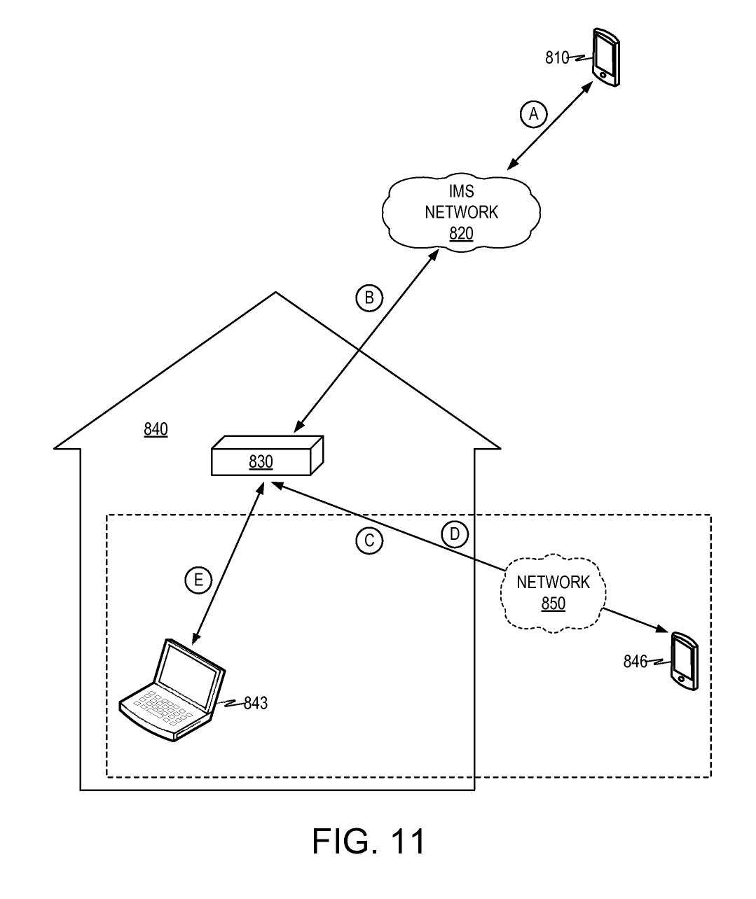

FIG. 11 shows a variation of the environment of FIG. 10 in which the affiliated RTC client 846 is outside of the local home or office network but within the affiliation network 840 and reachable through network 850. The RTC client 846 is the designated affiliated RTC client in this example. When an incoming call is made to the RTC host 830, the designated affiliated RTC client 846 rings (path C). The RTC client device 846 may answer the call (path D) and throw the call (paths D and E) to the RTC client device 843.

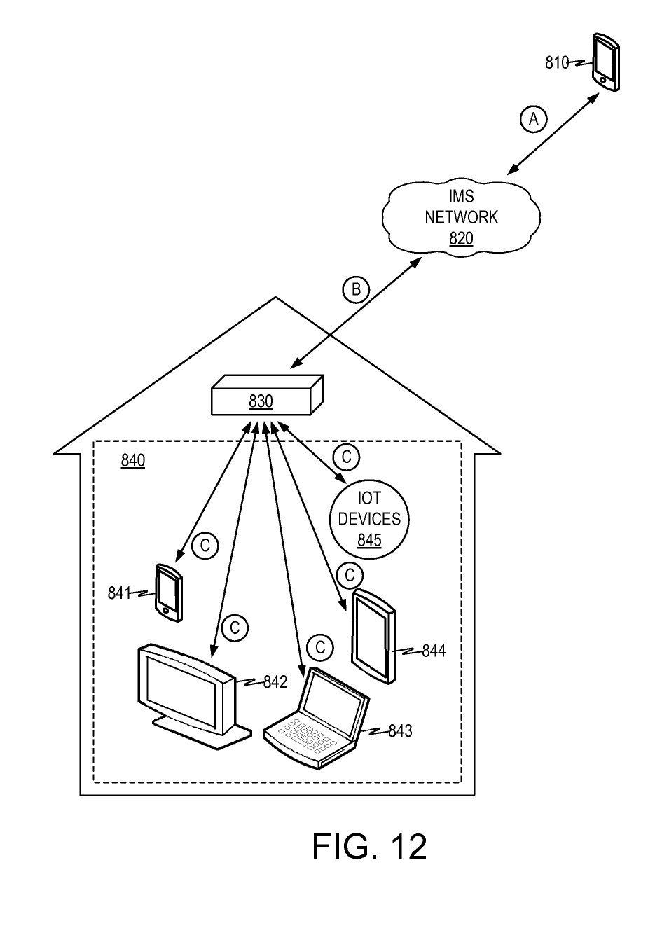

FIG. 12 shows a variation of the environment of FIG. 9 in which all affiliated devices are designated. When an incoming call is made to the RTC host 830, all of the affiliated RTC clients 841, 842, 843, 844 and 845 may ring (paths C). Any of the RTC clients may answer (not shown).

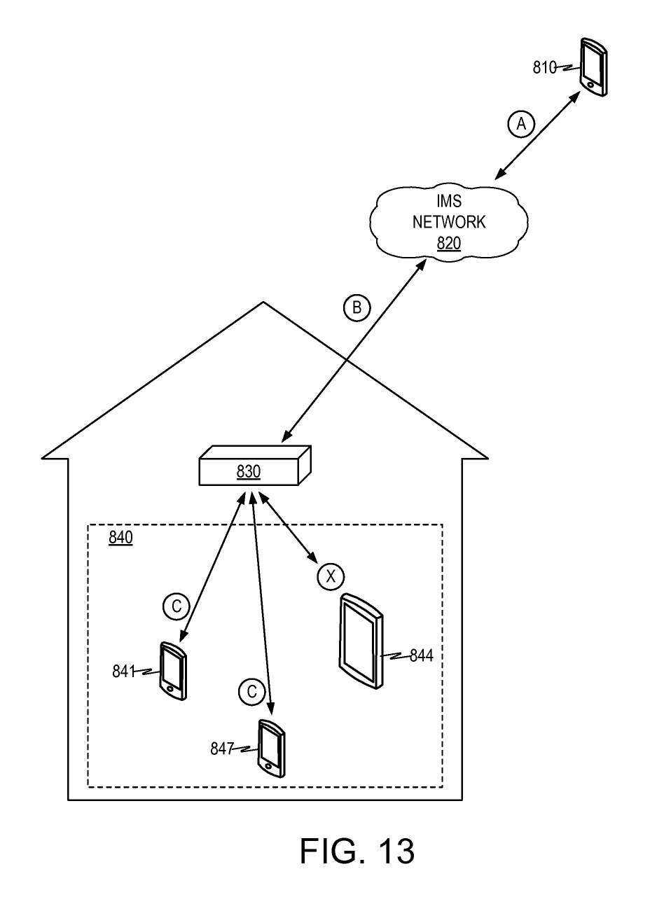

FIG. 13 shows an example of the RTC host 830 and multiple affiliated RTC clients 841, 844 and 847 realizing the allowing and blocking of RTC functions. The RTC host 830 may include a function that allows or blocks affiliated RTC clients to use the communications and messaging services offered by the RTC host 830. For example, in a home network, the tablet 844 may be blocked from participation. However, a visitor may bring in a RTC client enabled digital device such as a smartphone 847, which may be registered and allowed to participate in communications and messaging functions. The person administering the RTC host 830 may use a secured administration console running on the RTC host 830 to provide the details of the visitor RTC client and enable the visitor RTC client to be added as another affiliated RTC client. When the visitor leaves, the administrator may remove the visitor RTC client 847 from or may allow the visitor RTC client 847 to remain within the affiliation network for continued participation, even outside of the home if desired.

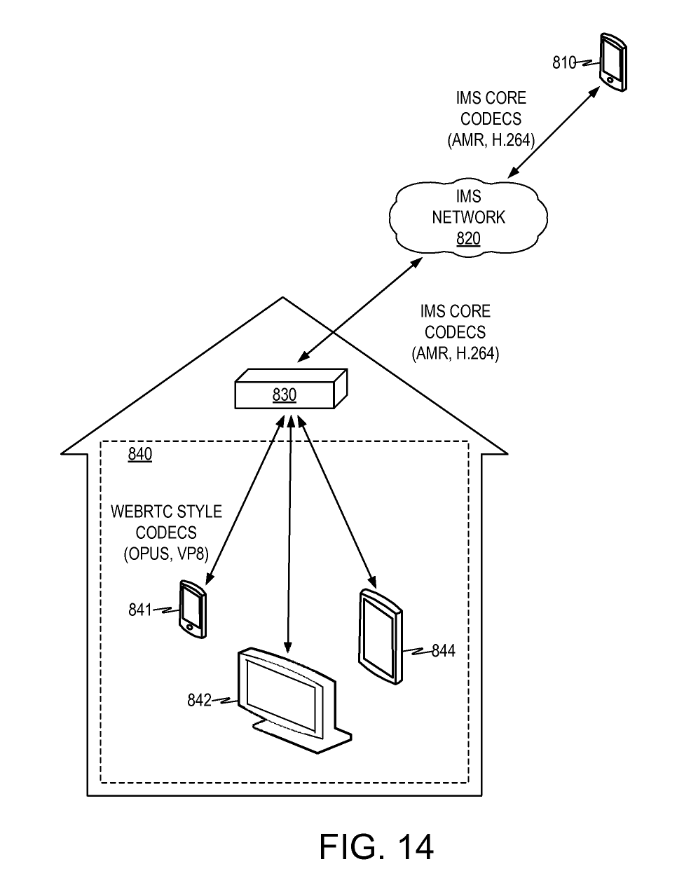

FIG. 14 shows an example of the RTC host 830 and multiple affiliated RTC clients 841, 842 and 844 realizing a media transcoding function. The RTC host is networked to a VoLTE network (the IMS network 820) on one side and to the affiliated RTC client devices 841, 842 and 844 over any type of IP network, here a Wi-Fi network. The affiliated RTC clients 841, 842 and 844 in this example illustratively are small footprint, simple applications which provide a call bridging functionality. To minimize infrastructure disruption, illustratively the RTC host 830 may connect to the VoLTE network through operator specified IMS/VoLTE standards so that media exchanges may use prescribed codecs such as AMR WB or AMR NB for voice and H.264 for video. The RTC clients 841, 842 and 844, on the other hand, in this example are lightweight implementations that use any available media codecs, thereby avoiding the burden and expense of creating and installing special codecs. To manage the differences in the media formats, the RTC host 830 may be provided with the ability to transcode between local codecs likely to be available on the RTC clients and the codecs expected and provided on the network side.

An example of a media transcoding function is the following. A RTC client which includes an Opus audio codec and a VP8 video codec captures and renders media using these codecs and sends the media to the RTC host without modification. The RTC host converts the media from the Opus and VP8 formats to, illustratively, the AMR WB and H.264 media formats, which are formats expected by the cellular network. Similarly, a RTC client may use very basic PCM for audio, which also is accepted by the RTC host, which in turn converts the PCM audio into the AMR WB format for the network side. On the reverse path, the RTC host converts the AMR WB and H.264 media formats into formats used by the various RTC clients. In such cases, the RTC host and each of the RTC clients involved in a media transmission engage in a dialog, which is similar to the Session Description Protocol (“SDP”) negotiation in SIP, to arrive at a transcode choice that is optimal. For example, a RTC client may support RTC style Opus, PCM, G.711 and AAC formats. The RTC host may support Opus as well as PCM. Since bandwidth requirements and latencies may be optimized by having both sides use the Opus format, the RTC host makes this determination and transcodes between Opus on one hand and AMR WB on the other. The negotiation can be extended to include other variables such as the health of the network connection between the RTC host and the RTC client; for example the available bandwidth can help select between PCM for it's simplicity versus Opus to minimize bandwidth usage. Furthermore, a number of secondary variables can also be factored into the negotiation; such as, for example, (a) the number of devices present in the network—different devices (SlingBox or a smart TV etc) can have high levels of bandwidth demand thereby reducing the available bandwidth; and (b) collisions on the same radio channels, which may adversely impact the effective throughput. Transcoding may impose real time performance requirements to ensure that the user does not experience any perceptible degradation in the media quality or a delay.

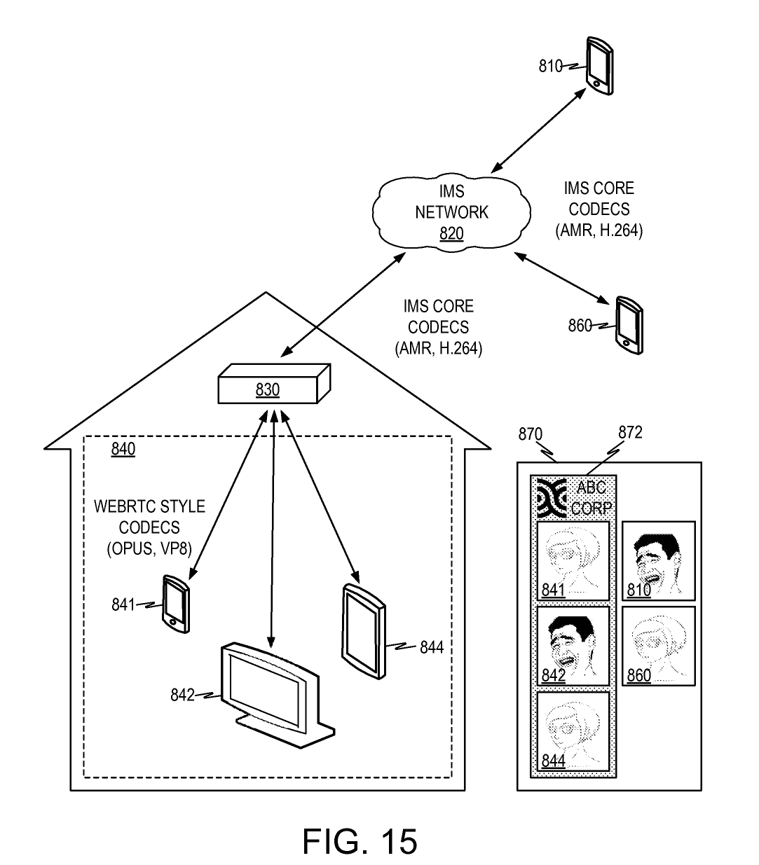

FIG. 15 shows a variation of the environment of FIG. 14 in which the RTC host 830 has the ability to video conference multiple RTC clients with an operator's video conference solution. Although transcoding is shown, such transcoding is a desirable but not a necessary feature of a conference environment. When a call is made or answered by one of the affiliated RTC client devices, illustratively the smartphone 841, the other affiliated RTC client devices may join the call, either under their own volition at any time or by invitation or in both ways, depending on how the RTC host 830 is administratively set up. Similarly, any of the conferenced RTC client devices may drop out of the conference at any time. Any of the RTC clients on the call may also add other RTC clients to the call. The administrative privileges on the RTC host 830 may be set so that any RTC client in the call may “lock” the call so that other RTC clients may not join the call under their own volition. In such a case, a RTC client already on the call may “invite” another RTC client to join in. A RTC client on a call need not be not restricted to adding only other affiliated RTC clients, but can also add non-affiliated RTC-enabled digital devices to the call.

The RTC host 830 mixes the individual media streams from the different affiliated RTC clients and advantageously may present a single unified media stream to the remote VoLTE callers, which advantageously reduces traffic on the operator's network and demand for network resources. A RTC host may also ensure that the multiple media streams between the affiliated RTC clients and the remote callers are normalized so that every one on the call perceives the same uniform audio levels, and may manage the multiple video stream components from the remote callers as well as those from the affiliated RTC clients into a composite video screen so that all parties can see others as well as presentation screens generated. An example of such a screen is shown in FIG. 15, wherein a composite video screen 870 shows a real time video image of all five parties to the conference, specifically the users of RTC-enabled digital devices 810, 841, 842, 844, and 860, and identifies all of the parties by their logical names. The RTC host 830 may also provide various enhancements to the video stream provided to the network, including augmentation, optimization scaling, and other effects. Illustratively, the video images from the affiliated RTC clients may be nestled in a background 872 identifying the family or enterprise, illustratively ABC CORP, so that the video images appear in a distinctive manner. This use case may be of particular interest in an enterprise setting where the affiliated RTC clients may be in different areas of the office building using different types of RTC-enabled digital devices.

The RTC host 830 may also manage the video resolutions and frame rates in addition to managing the video format compatibility between the affiliated RTC clients, and in the case of conferencing with non-affiliated RTC-enabled digital devices, between the affiliated RTC clients an operator's video conferencing solution. The affiliated RTC clients may be in an environment that offers high data bandwidth and support for higher video resolutions and frame rates than that supported over the operator's cellular network. In such cases, the RTC-enabled digital devices on which the affiliated RTC clients are installed may show higher resolutions at higher frame rates for a smooth and realistic video conferencing experience. The RTC host may optimize the video conferencing experience for the affiliated RTC clients to the best of the capabilities of the respective RTC-enabled digital devices, while at the same time ensuring that the composite video interfaced to the operator's network complies with the expected video formats, resolution and frame rates.

Another example of a suitable digital device on which a RTC host may be installed is a camera, including both video and still. Video and still cameras are increasingly becoming sophisticated with the inclusion of wireless communication, GPS support, and NFC capabilities. Examples include the Nikon 610 device with Wi-Fi capabilities, the Sony POV Action Camera with GPS, and the Sony DSC-QX10 device which has both Wi-Fi as well as NFC capabilities. The RTC host installed on a RTC-enabled camera may make the captured video available to affiliated RTC clients, whether in close physical proximity or remote. In such cases the video camera may augment the locally saved video by simultaneously saving it in a remote RTC-enabled digital device. Another example is the case of a parent using a RTC-enabled video camera on which a RTC host is installed to capture a child's graduation ceremony and share it with one or more affiliated RTC clients to enable friends and family to simultaneously view the event from wherever they happen to be, whether local or remote.

Another example of a suitable digital device on which a RTC host may be installed is an aerial drone having one or more video cameras. The RTC host may combine and optimize the component video streams, and deliver the composite to affiliated RTC clients.

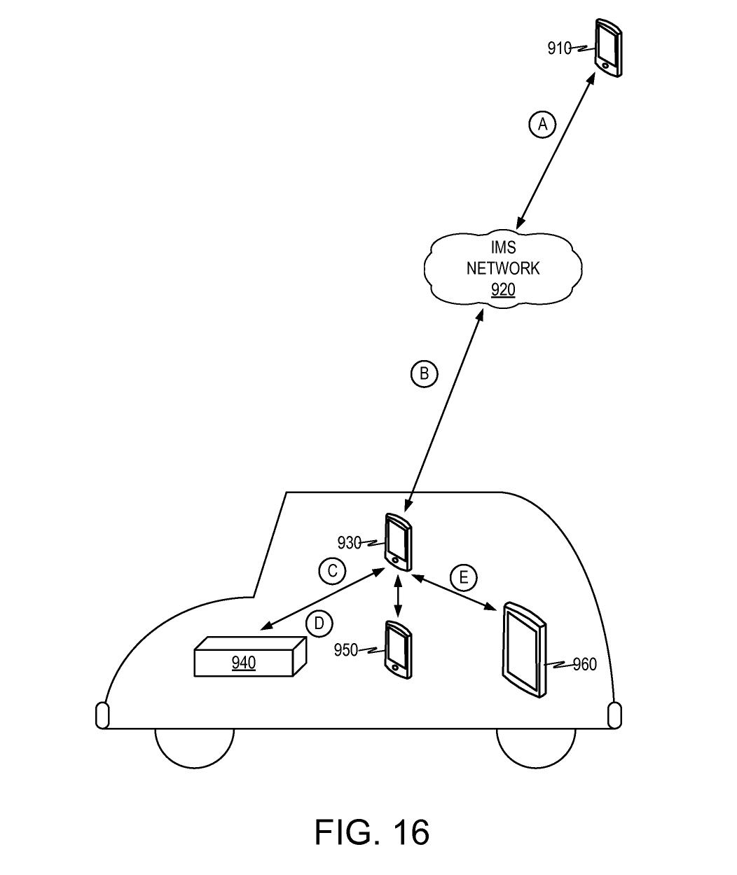

FIG. 16 shows an example of how a RTC host supports local twinning. The environment shown is illustratively a car, although twinning may be done with any affiliated RTC client in any type of affiliation group. Twinning refers to enabling a secondary device to offer services and features that are available in a primary device. If a smartphone 930 contains a RTC host, it may be considered to be the primary device and may be twinned with any of the affiliated RTC client devices, such as a head unit 940, another smartphone 950, and a tablet 960. Even if a device such as the head unit 940 contains only a RTC client, the smartphone 930 as RTC host may be twinned with the head unit 940 so that the head unit may offer all or a subset of services and features available on the smartphone 930. An example of a feature is that the head unit 940 may place an outgoing call as if the call were from the smartphone 930, including the “phone” number of the RTC host in the smartphone 930. In another example, the RTC host in the smartphone 930 may receive a call, and then may send the call invitation to designated affiliated RTC clients. Similarly, other services such as messaging (SMS, MMS) may be made available to affiliated RTC clients. The identities of such affiliated RTC clients such as the device serial number may be stored in the ISIM application on UICC. The list of identities may be retrieved by the service provider network for subscriber management, billing and other operational needs. Depending upon the available storage space and service provider needs, other parameters and data relevant for RTC functions such as number of calls, key error messages, and so forth may be stored in the ISIM application and may be retrieved by the service provider to manage Quality of Experience for the RTC services.

Although twinning is practiced in the mobile communications industry, it is done using the infrastructure of a service provider's network. This mechanism has many limitations. One of them is that the network needs to be aware of all the twinned devices and would need to send multiple invitations for the call. Such an implementation is costly and poses scalability issues as the number of twinned devices grow. Advantageously, local twinning shifts the twinning burden off of the service provider's network. When a smartphone receives a call, for example, it looks up a list of locally twinned devices and sends the call invitation to them. The service provider's network sends only one call invitation to the RTC host, while the RTC host carries the burden of sending multiple call invitations to the locally twinned devices.

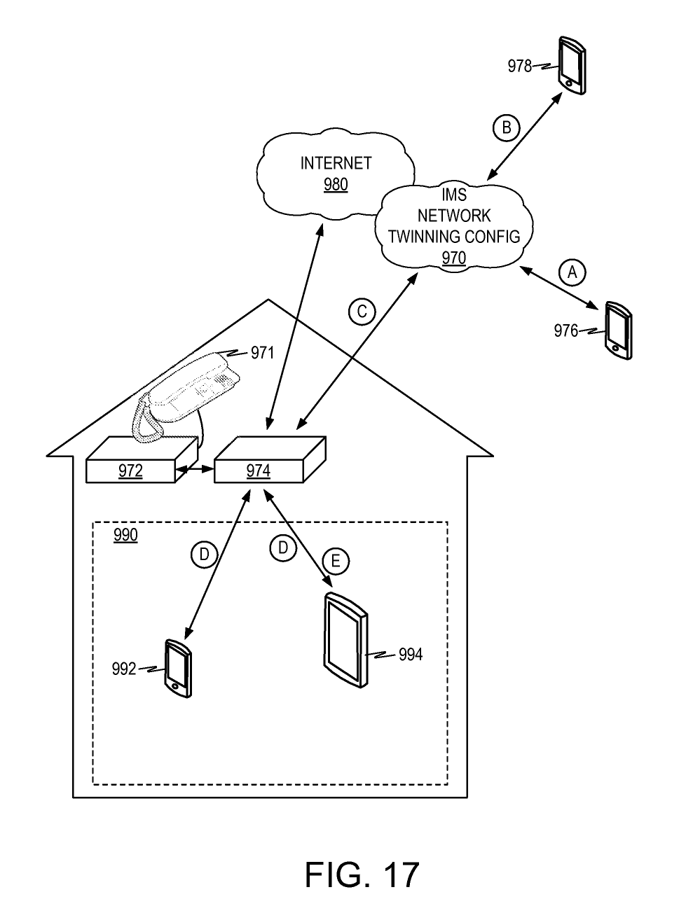

A RTC host may be twinned to a non-affiliated RTC-enabled digital device using the twinning capability of an operator's network. FIG. 17 shows a deployment example wherein a cellphone 978 is provisioned in an operator's IMS/LTE network 970 with a twinning capability. This allows a secondary device such as a RTC host enabled internet and cable television box 974 to be identified and associated with the cellphone 978. The internet and cable television box 974 may be a suitably modified unit such as a FiOS box, wireless home phone, or a Mi-Fi mobile hotspot which are available from Verizon Communications Inc. of New York, N.Y., USA; or a XFINITY® box from Comcast Corporation of Philadelphia, Pa., USA. The internet and cable television box 974 may use a cellular or fixed line connection to the service provider network. The cellphone 978 may be identified to the IMS/LTE network on the basis of the SIM card, newer versions of which are the USIM and the UICC. The secondary device, the internet and cable television box 974, may be host to many affiliated RTC-enabled digital devices of different types within affiliation network 990, such as, for example, cellphone 992 and tablet 994. The internet and cable television box 974 functions as proxy for the cellphone 978—in the event there of an incoming call to the cellphone 976 to the cellphone 978, the internet and cable television box 974 may also ring the cellphone 992, the tablet 994, or both, depending on the designations. In this manner, incoming calls may be taken by the cellphone 978 or by the cellphone 992 or the tablet 994. Similarly, outgoing calls may originate from the cellphone 978 or from the cellphone 992 or the tablet 994. As shown in FIG. 17, a call from the cellphone 976 to the cellphone 978 (path A) causes the cellphone 978 to ring (path B), but also causes the cellphone 992 and the tablet 994 to ring simultaneously (paths C and D). As shown, the tablet 994 accepts the call and is connected to the cellphone 976 (paths A, C, E). A home phone box 972 may be provided with a RTC client and registered with the RTC host 974, which enables traditional land-line corded phones (shown at 971) and cordless phones (not shown) to ring along with cellphone 992 and tablet 994.

Secondary devices may not have an integrated SIM, USIM or UICC to aid identification. In such cases, the service provider may use soft credentials such as a password protected user ID to associate the secondary device with the primary device. Furthermore the communication to authenticate the secondary device into the service provider's IMS/LTE network may be encrypted. To support encryption, the RTC host may be enabled with the appropriate encryption mechanisms to allow secure authentication with the service provider's IMS/LTE networks as well as a secure token that uniquely associates it with the SIM (USIM or UICC) inside the primary device, here the cellphone 978.

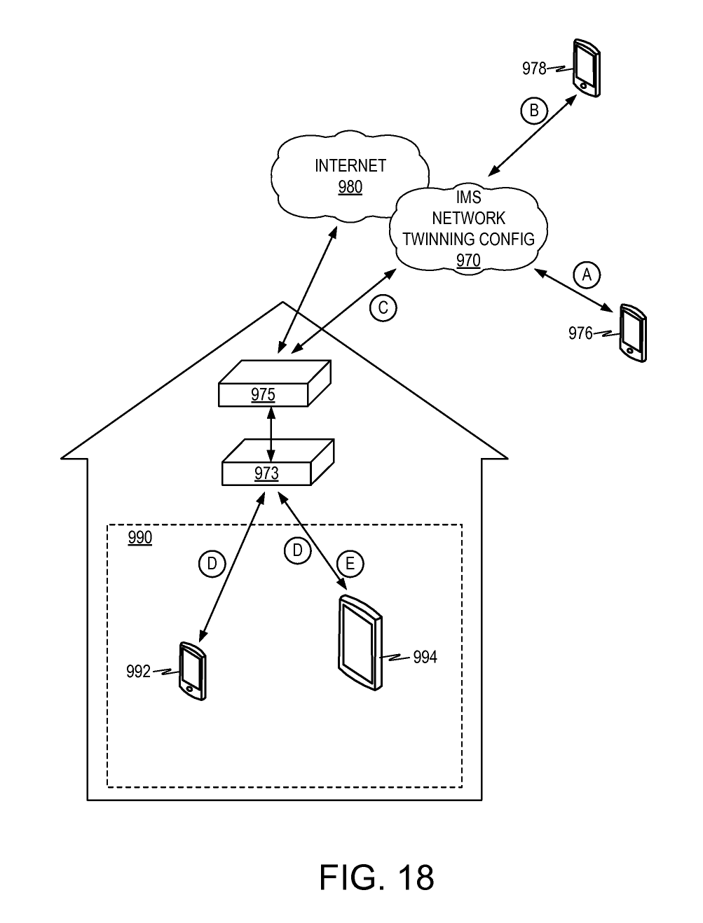

FIG. 18 is similar to FIG. 17 except that the internet and cable television box 975 is a conventional unit, and the RTC host is packaged as a purpose-specific internet appliance 973. The internet appliance 973 illustratively supports the secure authentication mechanisms needed to connect to the IMS/LTE network, as well as those needed to associate it with the SIM (USIM or UICC) card in the cellphone 978. The internet appliance 973 is provisioned as a secondary device for the cellphone 978 by virtue of the operator's network with the twinning functionality. Incoming calls to the cellphone 978 are also directed to the internet appliance 973, which acting as a host may ring any of the RTC-enabled digital devices 992 and 994. Any of the RTC-enabled digital devices 992 and 994 may place outgoing VoLTE calls, which have the same Caller ID attributes as the cellphone 978.

The various embodiments of the invention described herein are illustrative of our invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention, as set forth in the following claims.

1. A real-time rich communications (“RTC”) system comprising:
a network infrastructure comprising one or more networks;
a real-time rich communications (“RTC”) host installed on a RTC-enabled digital device, the RTC host comprising a plurality of core communication and messaging services for real-time rich communications and configured as a client to access Internet Protocol (“IP”) multimedia services running on a Session Initiation Protocol/Internet Protocol Multimedia Subsystem (“SIP/IMS”) core over the network infrastructure in a client-server relationship; and
a plurality of affiliated RTC clients installed on respective real RTC-enabled digital devices and configured as clients to interact with the RTC host in respective client-server relationships;
wherein the RTC host is further configured as a server to provide any one or more of the core communication and messaging services to the affiliated RTC clients.

2. The real-time rich communications system of claim 1, wherein the core communication and messaging services in the RTC host comprise two or more of a SIP/IMS framework, a Voice over IP (“VoIP”) framework, a video framework, a RCS-e/RCS framework, and a SMS over IMS framework, and the SIP/IMS framework.

3. The real-time rich communications system of claim 1, wherein the core communication and messaging services in the RTC host comprise a SIP/IMS framework, a Voice over IP (“VoIP”) framework, a video framework, a RCS-e/RCS framework, and a SMS over IMS framework, and the SIP/IMS framework, the VoIP framework, the video framework, the RCS-e/RCS framework, and the SMS over IMS framework being coupled.

4. The real-time rich communications system of claim 3, wherein the core communication and messaging services in the RTC host further comprise an Internet of Things (“IoT”) framework.

5. The real-time rich communications system of claim 3, wherein the VoIP framework, the video framework, the RCS-e/RCS framework, and the SMS over IMS framework are modular and plugged into the SIP/IMS framework.

6. The real-time rich communications system of claim 3, wherein
the VoIP framework and the video framework are combined into a modular VoIP/Video framework that is plugged into the SIP/IMS framework; and
the RCS-e/RCS framework and the SMS over IMS framework are modular and plugged into the SIP/IMS framework.

7. The real-time rich communications system of claim 3, wherein at least two of the VoIP framework, the video framework, the RCS-e/RCS framework, and the SMS over IMS framework are combined into a single framework.

8. The real-time rich communications system of claim 3, wherein at least two of the VoIP framework, the video framework, the RCS-e/RCS framework, and the SMS over IMS framework are loaded together at runtime.

9. The real-time rich communications system of claim 1 wherein the RTC host is installed in a purpose-specific internet appliance.

10. The real-time rich communications system of claim 1 wherein one of the RTC clients is installed on the RTC-enabled digital device on which the RTC host is installed.

11. The real-time rich communications system of claim 1 wherein the RTC host is further configured for supporting call throw among two or more of the affiliated RTC clients.

12. The real-time rich communications system of claim 1 wherein the RTC host is further configured for supporting conferencing among two or more of the affiliated RTC clients.

13. The real-time rich communications system of claim 1 wherein the RTC host is further configured for supporting conferencing among at least one unaffiliated RTC-enabled digital device and two or more of the affiliated RTC clients.

14. A real-time rich communications (“RTC”) host installed on a RTC-enabled digital device, comprising:
a plurality of core communication and messaging services for real-time rich communications;
one of the core communication and messaging services using a Session Initiation Protocol/Internet Protocol Multimedia Subsystem (“SIP/IMS”) framework configured as a client to access Internet Protocol (“IP”) multimedia services running on a SIP/IMS core over a network infrastructure in a client-server relationship, and
others of the core communication and messaging services using one or more frameworks that are coupled to the SIP/IMS framework; and
a local call control server and a media framework configured as a server to provide any one or more of the core communication and messaging services to one or more affiliated RTC clients installed on one or more networked RTC-enabled digital devices in respective one or more client-server relationships.

15. The real-time rich communications host of claim 14, wherein the core communication and messaging services comprise two or more of a SIP/IMS framework, a Voice over IP (“VoIP”) framework, a video framework, a RCS-e/RCS framework, and a SMS over IMS framework, and the SIP/IMS framework.

16. The real-time rich communications host of claim 14, wherein the core communication and messaging services comprise a SIP/IMS framework, a Voice over IP (“VoIP”) framework, a video framework, a RCS-e/RCS framework, and a SMS over IMS framework, and the SIP/IMS framework, the VoIP framework, the video framework, the RCS-e/RCS framework, and the SMS over IMS framework being coupled.

17. The real-time rich communications host of claim 16, wherein the core communication and messaging services further comprise an Internet of Things (“IoT”) framework.

18. The real-time rich communications host of claim 16, wherein the VoIP framework, the video framework, the RCS-e/RCS framework, and the SMS over IMS framework are modular and plugged into the SIP/IMS framework.

19. The real-time rich communications host of claim 16, wherein
the VoIP framework and the video framework are combined into a modular VoIP/Video framework that is plugged into the SIP/IMS framework; and
the RCS-e/RCS framework and the SMS over IMS framework are modular and plugged into the SIP/IMS framework.

20. The real-time rich communications host of claim 16, wherein at least two of the VoIP framework, the video framework, the RCS-e/RCS framework, and the SMS over IMS framework are combined into a single framework.

21. The real-time rich communications host of claim 16, wherein at least two of the VoIP framework, the video framework, the RCS-e/RCS framework, and the SMS over IMS framework are loaded together at runtime.

22. The real-time rich communications host of claim 14 further configured for supporting call throw among two or more of the affiliated RTC clients.

22. The real-time rich communications host of claim 14 further configured for supporting conferencing among two or more of the affiliated RTC clients.

23. The real-time rich communications host of claim 14 further configured for supporting conferencing among at least one unaffiliated RTC-enabled digital device and two or more of the affiliated RTC clients.

24. A method for providing real-time rich communications comprising:
registering one or more affiliated real-time communications (“RTC”) clients installed on one or more RTC-enabled digital devices on a RTC host installed on a RTC-enabled digital device;
the RTC host comprising a plurality of core communication and messaging services for real-time rich communications and configured as a client to access Internet Protocol (“IP”) multimedia services running on a Session Initiation Protocol/Internet Protocol Multimedia Subsystem (“SIP/IMS”) core over a network infrastructure in a client-server relationship;
the one or more affiliated RTC clients being respectively configured as one or more clients to interact with the RTC host in respective one or more client-server relationships; and
the RTC host being further configured as a server to provide any one or more of the core communication and messaging services to the one or more affiliated RTC clients;
establishing a signaling plane between the one or more affiliated RTC clients and at least one unaffiliated RTC-enabled digital device over a network infrastructure using at least one of the communication and messaging services of the RTC host; and
establishing a media transport plane between the one or more affiliated RTC clients and at least one unaffiliated RTC-enabled digital device over a network infrastructure using at least one of the communication and messaging services of the RTC host.

25. The method of claim 24, wherein the core communication and messaging services in the RTC host comprise two or more of a SIP/IMS framework, a Voice over IP (“VoIP”) framework, a video framework, a RCS-e/RCS framework, and a SMS over IMS framework, and the SIP/IMS framework.

26. The method of claim 24, wherein the core communication and messaging services in the RTC host comprise a SIP/IMS framework, a Voice over IP (“VoIP”) framework, a video framework, a RCS-e/RCS framework, and a SMS over IMS framework, and the SIP/IMS framework, the VoIP framework, the video framework, the RCS-e/RCS framework, and the SMS over IMS framework being coupled.

27. The method of claim 26, wherein the core communication and messaging services in the RTC host further comprise an Internet of Things (“IoT”) framework.

28. The method of claim 26, wherein the VoIP framework, the video framework, the RCS-e/RCS framework, and the SMS over IMS framework are modular and plugged into the SIP/IMS framework.

29. The method of claim 26, wherein
the VoIP framework and the video framework are combined into a modular VoIP/Video framework that is plugged into the SIP/IMS framework; and
the RCS-e/RCS framework and the SMS over IMS framework are modular and plugged into the SIP/IMS framework.

30. The method of claim 26, wherein at least two of the VoIP framework, the video framework, the RCS-e/RCS framework, and the SMS over IMS framework are combined into a single framework.

31. The method of claim 26, wherein at least two of the VoIP framework, the video framework, the RCS-e/RCS framework, and the SMS over IMS framework are loaded together at runtime.

32. The method of claim 24 wherein the RTC host is further configured for supporting call throw among two or more of the affiliated RTC clients, further comprising throwing a call among the two our more affiliated RTC clients via the RTC host.

33. The method of claim 24 wherein the RTC host is further configured for supporting conferencing among two or more of the affiliated RTC clients, further comprising conferencing among the two our more affiliated RTC clients via the RTC host.

34. The method of claim 24 wherein the RTC host is further configured for supporting conferencing among at least one unaffiliated RTC-enabled digital device and two or more of the affiliated RTC clients, further comprising conferencing among the at least one unaffiliated RTC-enabled digital device and the two our more affiliated RTC clients via the RTC host.
